(19) United States
(12) Patent Application Publication
(10) Pub. No.: US 2010/0307869 A1
(43) Pub. Date: Dec. 9, 2010

(54) UNIVERSAL PLATFORM DEVICE AND METHOD

(76) Inventors: Edward Richard Hazuka, II, Makawao, HI (US); Michael Paul Chaffeur, Kent, WA (US); William J. Ponte, SR., Makawao, HI (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/756,885

(22) Filed: Apr. 8, 2010

Related U.S. Application Data
(60) Provisional application No. 61/169,177, filed on Apr. 14, 2009.

(51) Int. Cl. E04G 1/32; A47F 5/12; F16M 11/06; E04G 1/24

(52) U.S. Cl. 182/141; 108/6; 108/7; 182/179.1

(57) ABSTRACT

A universal platform device includes a support member and at least one base member having a first surface configured to be positioned on a primary surface. The base member can be pivotably coupled to the support member, and includes a plurality of gaseous cells at least toward the first surface and flexible regions at least between the respective gaseous cells. The weight of the object or person being supported on platform device deforms the flexible material and the gaseous cells. Upon deformation of the flexible regions and gaseous cells, the shape of the mating portion substantially conforms to the shape of the primary surface. The gaseous cells at the mating portion expand to form numerous suction cups and the base member clasps on to the primary surface.

### CROSS-REFERENCE TO RELATED APPLICATION

This application claims the benefit under 35 U.S.C. §119(e) of U.S. Provisional Patent Application No. 61/169,177, filed Apr. 14, 2009, where this provisional application is incorporated herein by reference in its entirety.

### BACKGROUND

1. Technical Field

The present disclosure is generally related to platforms and support devices, and more particularly, to a universal platform device that can be supported on surfaces of varying slopes and contours, and is easily moveable.

2. Description of the Related Art

Conventional support devices and platforms that are used to support a weight of an object, such as people, equipment and/or material, on a surface, such as on a ground surface or on a roof of a building, are typically time-consuming to assemble and manipulate. These devices generally require substantial mechanical fastening to secure to a surface, thereby impeding mobility and being practically impossible to provide support on a surface that is not amenable to mechanical fastening. For example, existing support devices are typically customized for the type of surface on which they are intended to support the weight, and therefore, supporting the weight on different surfaces requires a separate support device. For example a support device intended for supporting a person or an object on a roof of a building is generally not suitable for indoor uses.

Furthermore, existing devices, even if intended for use on multiple types of surfaces, generally require some form of external fastening system, such as mechanical fasteners to secure them to the surface. Therefore, when using these conventional devices in applications that require repeatedly moving the devices, a user has to repeatedly fasten and unfasten the device to move it. Therefore, the process of mounting conventional devices is time consuming and labor intensive, resulting in higher associated costs.

Even conventional support devices that are moveable, such as ladders and step stools, are limited in use and mobility. For example, ladders are typically wedge-shaped and can only be supported on a flat surface, while a portion thereof either interferes with the user's access to a work area, or the wedge-shape results in an undesirable space or gap between the user an the work area. Similarly, step stools are limited to the surface on which they are placed and the weight which they can stably support. These devices are typically not suitable for supporting a weight on inclined and/or contoured surfaces.

In addition, support accessories for auxiliary support or storage devices, such as back packs, toolboxes, and the like, are awkward and/or limited as to the type of surface or contour on which they can be placed.

### BRIEF DESCRIPTION OF THE SEVERAL VIEWS OF THE DRAWINGS

FIG. 1 is an isometric view schematically illustrating a universal platform device having a pair of base members with cells separated by flexible regions, according to one embodiment.

FIG. 2 is a close-up view of a portion of one of the base members of FIG. 1, illustrating the cells separated by the flexible material.

FIG. 3 is a photograph depicting an individual being supported on a portion of a tractor bucket on a universal platform device according to another embodiment with a support member of the universal platform device selectively pivoted with respect to respective base members thereof and secured at a particular angle with respect to the base members to provide a flat surface on which the individual is standing.

FIG. 4 is a close-up view of a base member of the universal platform device of FIG. 3, depicting a mating surface between a portion of the base member and the portion of the tractor bucket.

FIG. 5 is a close-up view of a base member of the universal platform device of FIG. 3, depicting a mating surface between a portion of the base member and a different non-symmetric portion of the tractor bucket.

FIG. 6 is a photograph depicting an individual being supported on a roof of a building on the universal platform device of FIG. 3 with the support member selectively pivoted with respect to the respective base members and secured at a particular angle with respect to the base members to provide a flat surface on which the individual is standing.

FIGS. 7 and 8 are close-up views of respective portions of FIG. 6, depicting mating regions between respective base members of the universal platform device and the roof of the building.

FIG. 9 is a photograph depicting two individuals being supported on an inclined hill with varying contour on the universal platform device of FIG. 3 with the support member selectively pivoted with respect to the respective base members and secured at a particular angle with respect to the respective base members to provide a flat surface on which the individuals are standing.

FIGS. 10 and 11 are close-up views of respective portions of FIG. 9, depicting mating regions between the respective base members of the universal platform device and different portions of the inclined hill, which have different respective slopes and contours.

FIG. 12 is a photograph depicting the universal platform device of FIG. 3 supported against two surfaces, namely, a ground and a wall of an interior of a building with the support member selectively pivoted with respect to the respective base members and secured at a particular angle with respect to the base members to provide a flat surface on which an individual can stand.

FIG. 13 is a photograph depicting the universal platform device of FIG. 3 supported on the ground surface of FIG. 12 with the support member pivoted at a substantially 90 degree angle with respect to the respective base members, demonstrating moveability of the support member with respect to base members.

FIG. 14 is a rear view of the universal platform device depicted in FIG. 13.

FIG. 15 is a front isometric view, schematically illustrating a universal support container having a base member with cells separated by flexible regions, according to yet another embodiment.

FIG. 16 is a front isometric view, schematically illustrating a universal support container having a base member with cells separated by flexible regions, and a selective adjustment mechanism, according to still another embodiment.

FIG. 17 is a side view, schematically illustrating a universal support footwear having a base member with cells separated by flexible regions, according to still another embodiment.

FIG. 18 is a side view, schematically illustrating a universal support footwear having a base member with cells separated by flexible regions, and a selective adjustment mechanism, according to a further embodiment.

FIG. 19 is a side view, schematically illustrating a universal support footwear having a base member with cells separated by flexible regions, and a selective adjustment mechanism, according to another embodiment.

FIG. 20 is an isometric view schematically illustrating a universal platform device having a base member with cells separated by flexible regions, a support member and a lift mechanism positioned between the base and support members, according to one embodiment.

### DETAILED DESCRIPTION

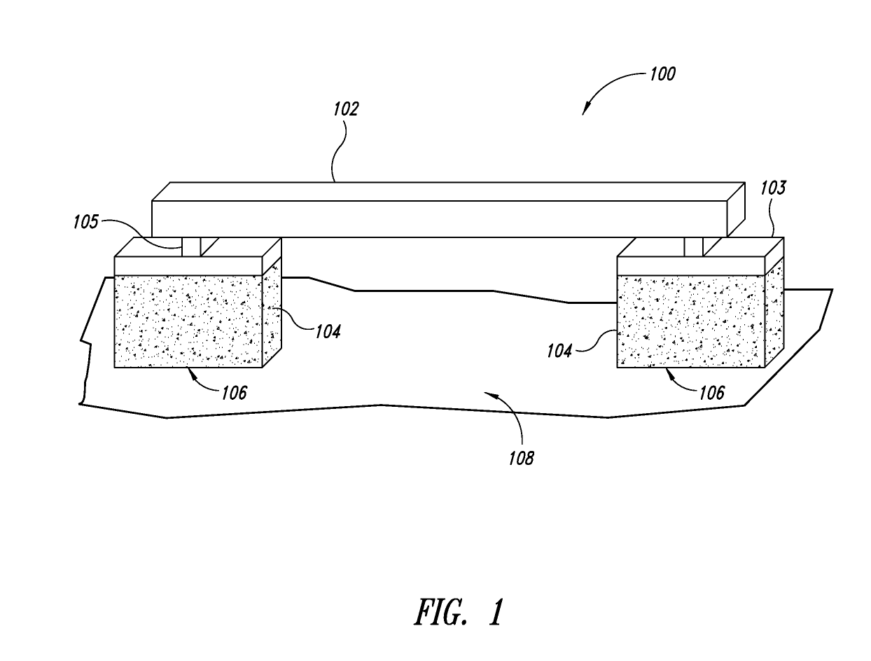

FIG. 1 schematically illustrates a universal platform device 100 according to one embodiment, including a support member 102 and at least one base member 104, which can be directly or indirectly coupled to the support member 102. In the illustrated embodiment of FIG. 1, the universal platform device 100 includes two base members 104, and the support member 102 extends, at least in part, between the two base members 104. The support member 102 is configured to support a weight thereon, and therefore, can be sized or shaped to any configuration that may be suitable for supporting the weight. For example, FIG. 1 illustrates an embodiment, in which the support member includes an elongated rectangular shape, which may be suitable for supporting a person standing on the support member 102.

The base members 104 each include a first surface 106, at least a portion of which can be positioned adjacent a primary surface 108 on which the universal platform device 100 is desired to be positioned and support the weight. The phrase “primary surface” is used throughout this application and the claims that follow to refer to any one or more surfaces on which a user desires to support the weight. Examples of primary surfaces 108 can include a ground surface, a roof, a wall, an edge of a beam or other component, or any other surface or any other structure on which the user desires to be supported or place an object. The primary surface 108 can also include more than one surface, for example, two surfaces that meet in a corner, a portion of the base members 104 resting on one of the two surfaces and another portion of the base members 104 resting on the other of the two surfaces, as will be described in more detail further below.

The universal platform device 100 can also include a mounting member 103 for mounting or coupling the base members 104 to the support member 102. The mounting member 103 can be fixedly coupled to the support member 102 directly or via an intermediate member 105. Alternatively, the intermediate member 105 can include an adjustment mechanism, allowing the mounting member 103, and therefore the respective base members 104, to selectively pivot and be fixed at a desired angle with respect to the support member 102, as will be described with respect to some embodiments in more detail further below.

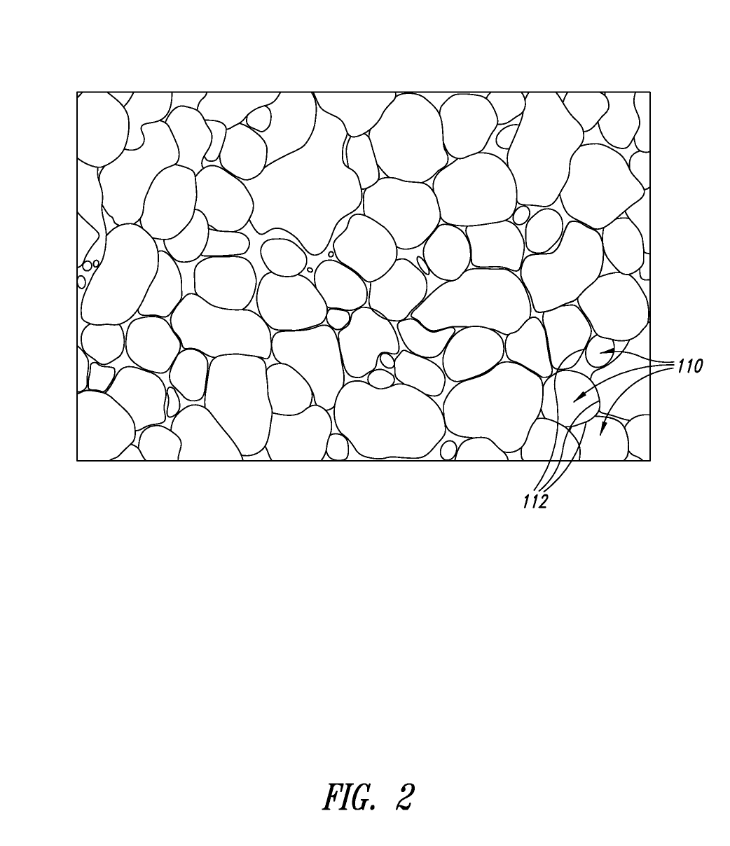

FIG. 2 is a close-up view of a portion of one of the base members 104 according to one aspect. As shown in FIG. 2, the base members 104 each include a plurality of pores or gaseous cells 110 at least toward a region thereof adjacent the first surface 106 (FIG. 1), and flexible regions or membranes 112 between, or surrounding, the cells 110. In one embodiment, the base member 104 (FIG. 1) can be fabricated from a material including a foam. For example, the foam can include dense foam, memory foam, latex foam, plastic foam, and/or high specification foam, or any other suitable foam material. Foam material is porous and flexible. In general, foam material comes in open and closed cell forms. Cells of open cell foams include a substantial number of cells in the foam that are not fully bound by material that separates the cells. In contrast, a substantial number of cells in closed cell foams are substantially bound by material that separates the cells.

Without any intention to exclude a particular configuration of the base member 104, embodiments in which a substantial number of at least the internal gaseous cells 110 are bounded, can provide improved support on the primary surface 108 and prevent slippage. Closed cell foams can therefore provide a desirable material for being used in at least a portion of the base members 104. In some embodiments, at least some of the cells 110 adjacent outer surfaces of the base member 104, such as those positioned at the first surface 106 (FIG. 1) are at least partially open. partially open cells at the first surface 106, at least a portion of which can form a mating surface between the base members 104 and the primary surface 108 (FIG. 1), expand during use when the base members 104 deform upon the universal platform device 100 being subjected to the weight. Such expansion of each of these cells 100 forms numerous suction cups at the mating surface to securely clasp on to the primary surface 108.

In some embodiments, at least a portion of the base members 104 is fabricated from a viscoelastic material, such as viscoelastic foams. Viscoelastic material exhibit increased resistance to shear when subjected to deformation, and therefore, in addition to the suction cups described above, can facilitate securely supporting the universal platform device 100 and an individual or object, even on an inclined or contoured surface, without requiring external fastening devices, such as mechanical fasteners.

As the weight is exerted on the support member 102, the corresponding force is transferred to the base member 104, deforming at least some of the flexible regions 112 and the cells 110. As the base members 104 deform, at least in the region toward the first surface 106, a mating region of the first surface 106 substantially conforms to the shape and contour of the primary surface 108 on which the base members 104 are positioned, effectively maintaining the suction cups against the primary surface 108 across an entire mating region between the base members 104 and the primary surface 108.

The following description is directed to supporting a weight on a number of different contours to provide a thorough understanding of base members and how they interact with primary surfaces having varying shapes, slopes, textures and contours. One of ordinary skill in the art will appreciate that the base members can be used on a variety of other types or shapes of primary surfaces without deviating from the scope of the present disclosure and the claims that follow.

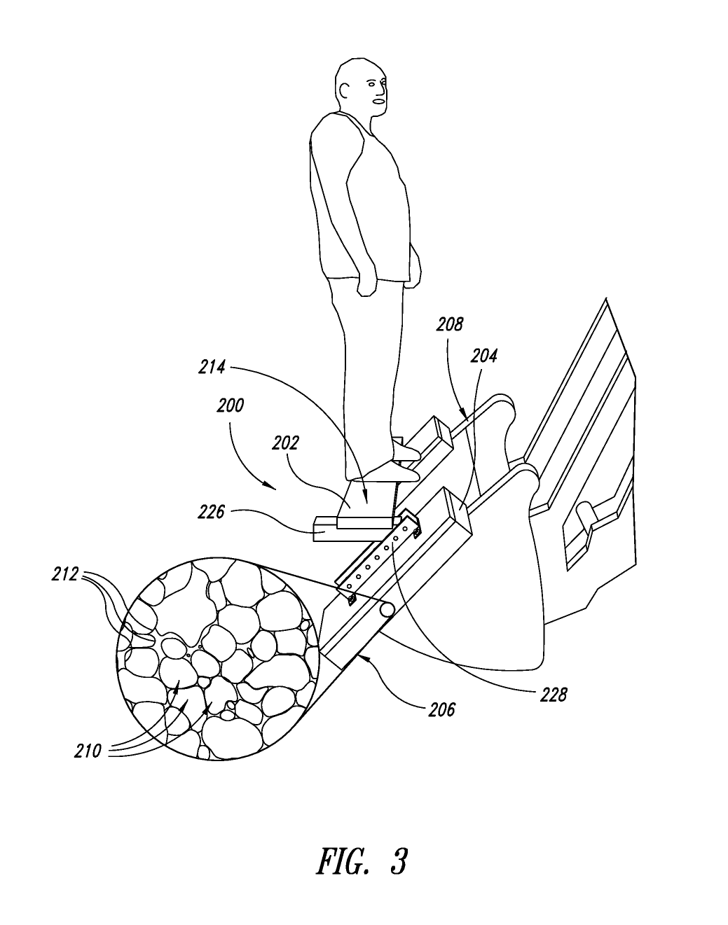

FIG. 3 depicts a universal platform device 200 according to one embodiment, during use. The universal platform device 200 includes a support member 202 and two base members 204, which are respectively pivotably coupled to the support member 202 toward opposing ends of the support member 202. The base members 204 each include a first surface 206 configured to be positioned on a primary surface 208. The support member 202 includes a support surface 214, which in the depicted embodiment of FIG. 3, is substantially flat and sized to allow a person stand on the support surface 214 and/or place an object thereon.

The user can selectively pivot the support member 202 with respect to each of the base members 204, respectively, to selectively position the base members 204 with respect to the primary surface 208 and orient the support member 202. For example, in the depicted embodiment of FIG. 3, the base members 204 are positioned on a tractor bucket and the support member 202 is oriented such that the support surface 214 is substantially horizontal. Examples of mechanisms for selectively pivoting the support member 202 with respect to one or both of the base members 204 are provided further below.

The user can therefore place the two base members 204 on opposing ends of the tractor bucket, respectively, such that the first surface 206 of each base member 202 extends at a substantially complementary angle with respect to the horizontal, as the angle at which the edges of the tractor bucket are sloped. Furthermore, the support member 202 can be pivoted with respect to the base members 204 to achieve a substantially horizontal support surface 214.

In some embodiments, such as the depicted embodiment of FIG. 3, the primary surface or surfaces 208, or a portion or portions thereof, on which the base members 204 are positioned and clasp to when the weight is applied to the support member 202, can be smaller than the area of respective first surfaces 206 of the base members 204.

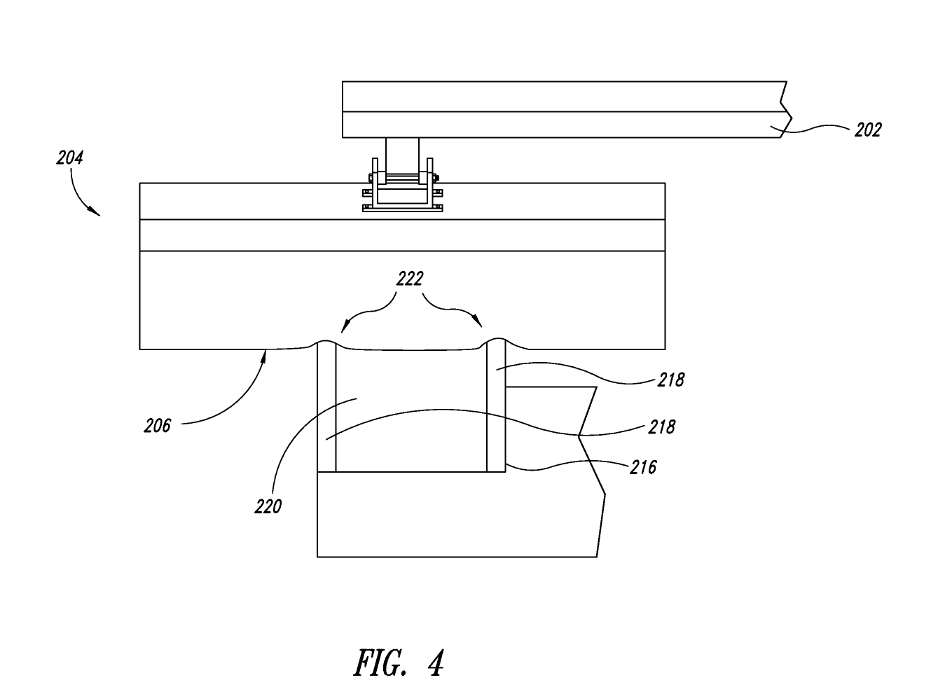

FIG. 4 is a plan view of one of the base members 204 of the universal platform device 200 shown in FIG. 3, clasping onto one end of the tractor bucket. As shown in FIG. 4, the end of the tractor bucket on which the base member 204 is positioned is a beam 216 having two opposing flanges 218 and a web 220 extending between the flanges 218.

When the weight is applied to the support member 202, a mating region or mating regions 222 of the first surface 206 of the base member 204 deforms, securely clasping to portions of the beam 216. Similar to the previous embodiment, the base member 204 includes a plurality of gaseous cells 210 (FIG. 3) formed by flexible regions, membranes or material 212 (FIG. 3) therebetween, allowing the base member 204 to deform in such a manner that the mating region 222 substantially conforms to at least a portion of the primary surface 208, such as the beam flanges 218, and clasp on to the primary surface 208 to prevent slippage. As shown in FIGS. 3 and 4, even when the base members 204 are positioned on a primary surface 208, such as the beam 216 of the tractor bucket, having steep angles, for example up to and exceeding 70 degrees with respect to the horizontal, the base members 204 securely engage the primary surface 208 and prevent slippage and other movement, without requiring any external fastening mechanisms, such as mechanical fasteners. The universal platform device has been shown to securely support weights up to and exceeding 500 pounds on various surfaces, inclined at slopes up to and exceeding 70 degrees.

Furthermore, the primary surface 208 need not be uniform or symmetrical for the base members 204 to securely engage and clasp to the primary surface 208.

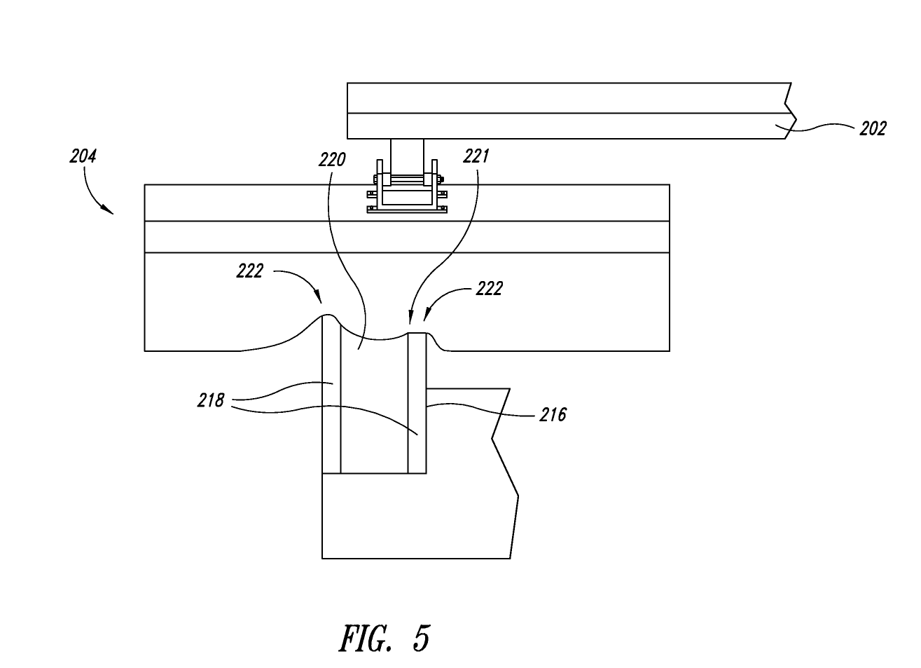

For example, in the embodiment depicted in FIG. 5, the base member 204 is positioned in a different, lower, portion of the tractor bucket end, in a location where the web 220 of the beam 216 has a region 221, toward one of the flanges 218, that is as thick as the flanges 218, resulting in a non-symmetric mating region 222. As depicted, the gaseous cells 210 (FIG. 3) and flexible regions 212 (FIG. 3) of the base member 204 allows the base member 204 to deform to conform to a shape or contour of a particular primary surface 208, or the mating region 222 thereof, which can be non-symmetric.

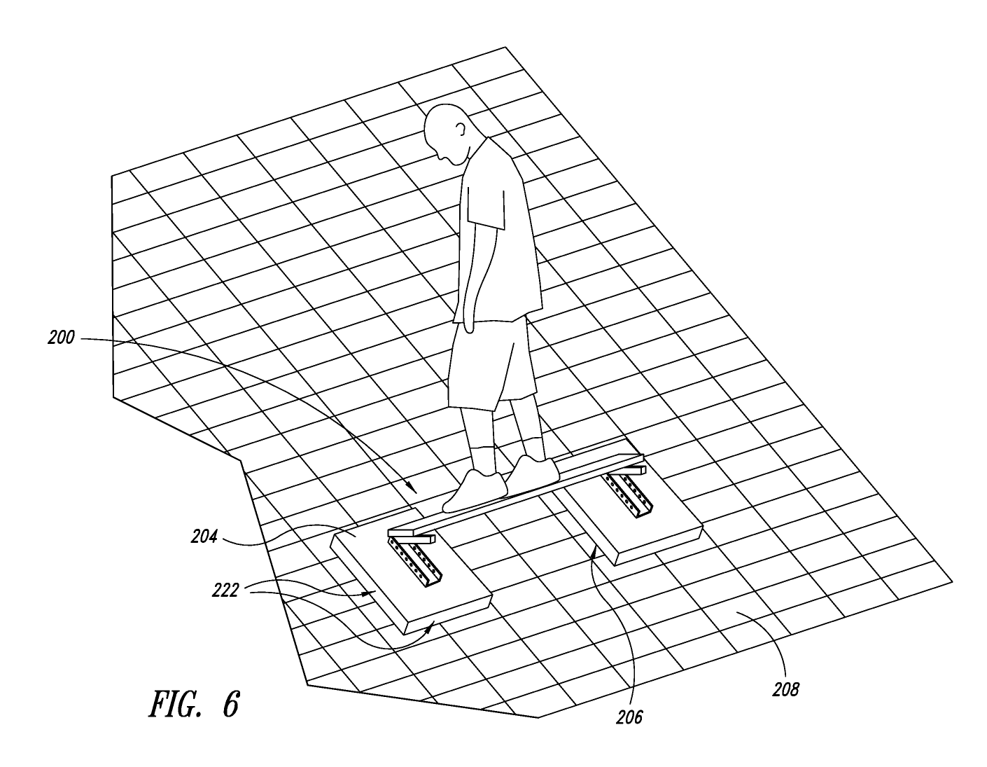

FIG. 6 depicts an application of the universal platform device 200 in which the primary surface 208 is larger than the first surfaces 206 of the base members 204. In the depicted application of FIG. 6, the universal platform device 200 is positioned on a sloped and textured roof of a building. In this particular example, the entire first surface 206 of each of the base members 204 constitutes the mating region 222.

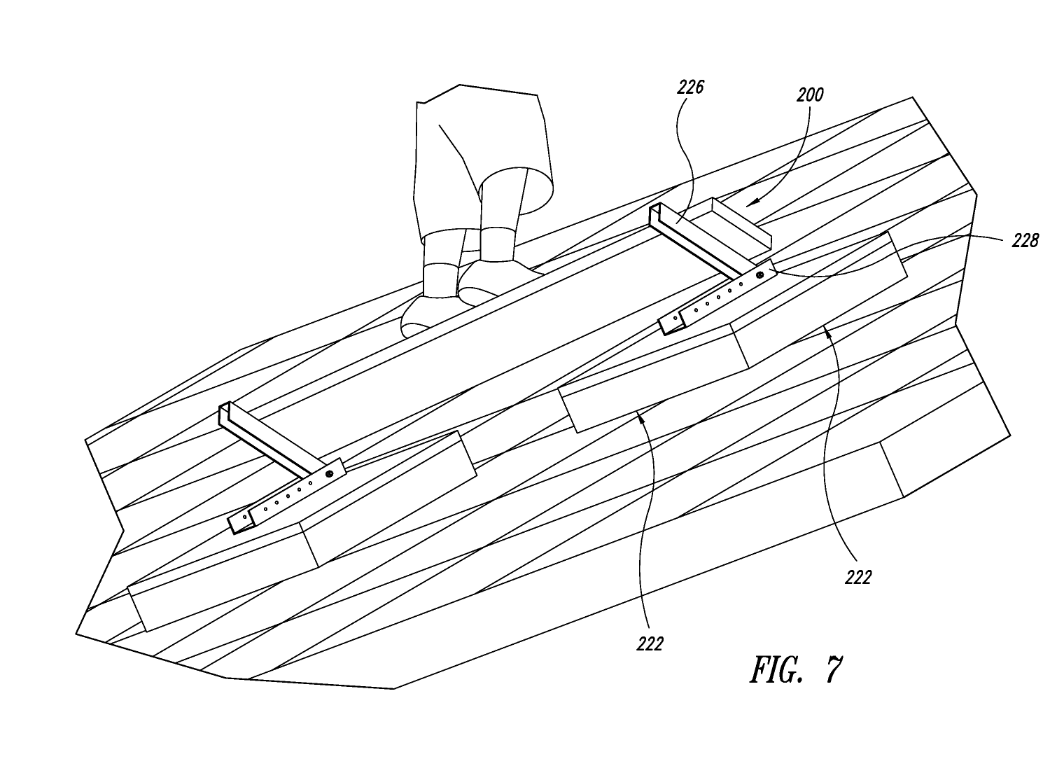

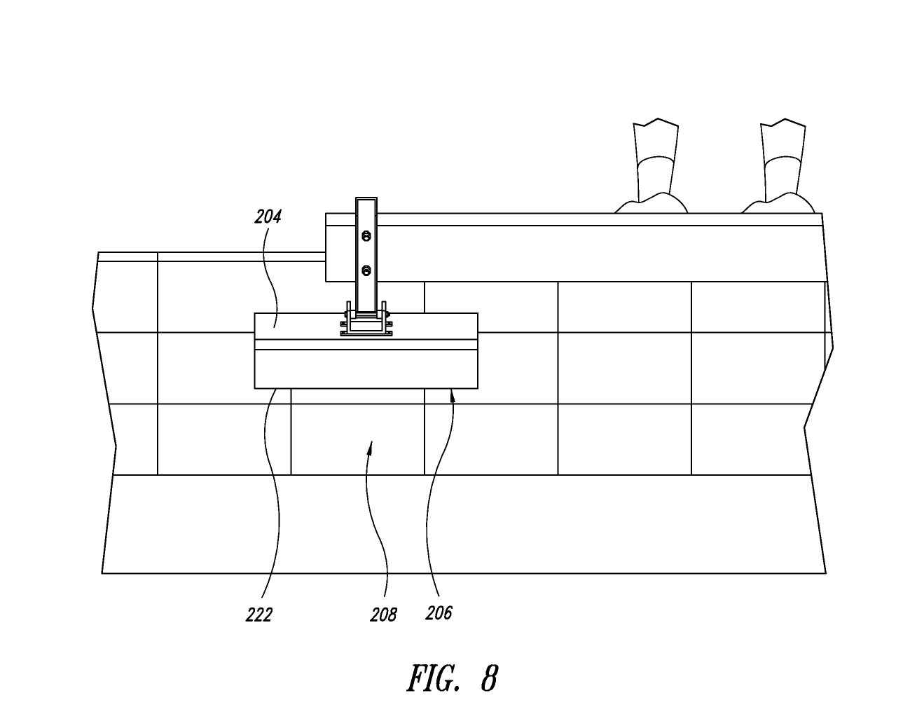

As depicted in FIGS. 7 and 8, the gaseous cells 210 and flexible regions 212 (FIG. 3) of the base members 204 deform to, in turn, bring about a particular deformation of the mating regions 222 of the respective base members 204, such that the mating regions 222 conform to the textured and sloped surface of the roof. A universal platform device according to an embodiment of the present disclosure, such as the universal platform device 200 depicted in FIGS. 6-8, is therefore very practical for use in roofing applications.

Existing devices used for roof maintenance purposes, for example, are typically required to be secured to the roof using external fastening mechanisms, such as mechanical fasteners. Therefore, when the user is working on a particular region of the roof, the user is required to secure existing devices in the vicinity of that region. When the user completes work on that region and proceeds to work on a different or even adjacent region of the roof, the user is required to mechanically unfasten existing devices from one region and refasten it to the roof in the vicinity of the next region. Accordingly, using existing devices can be extremely time and material consuming, and expensive.

In contrast, the user can simply lift a universal platform device according to an embodiment of the present disclosure, such as the universal platform device 200, and expediently move the device to any desired location without unfastening and refastening the device using external fastening mechanisms.

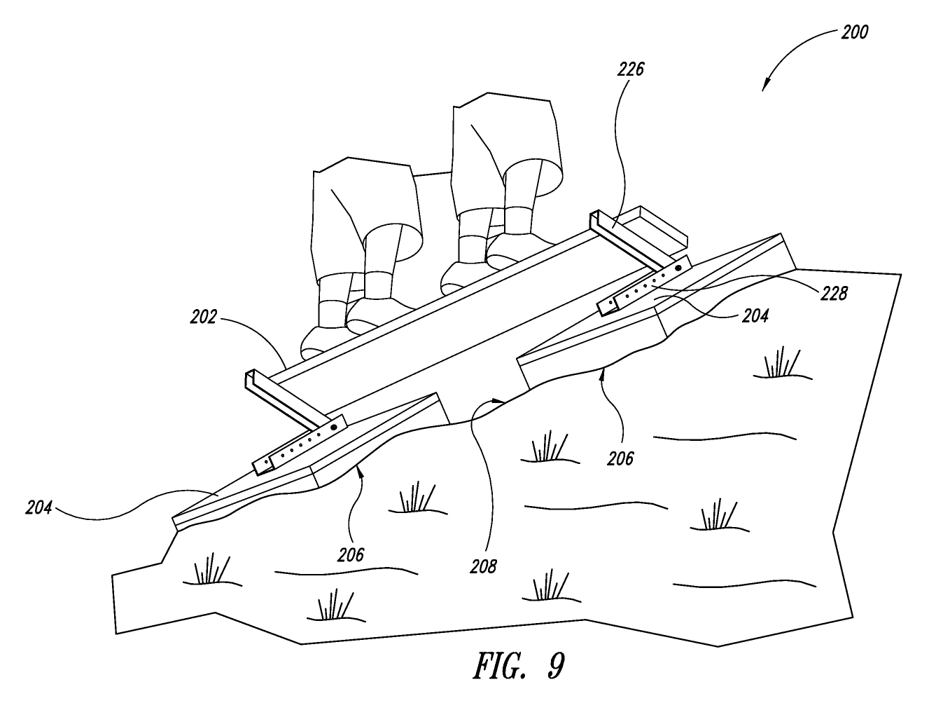

In the previous embodiment, the slope and texture of the roof is uniform; however, the universal platform device 200 can be secured on a primary surface that has both a non-uniform slope and a non-uniform texture, as depicted in FIGS. 9-11.

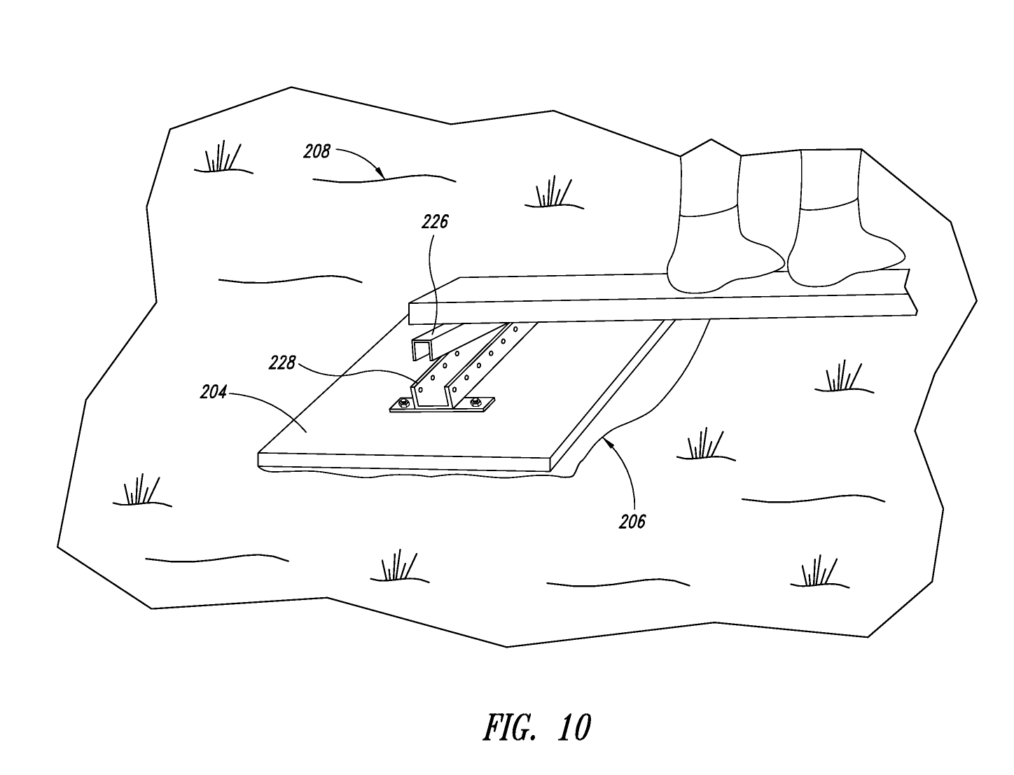

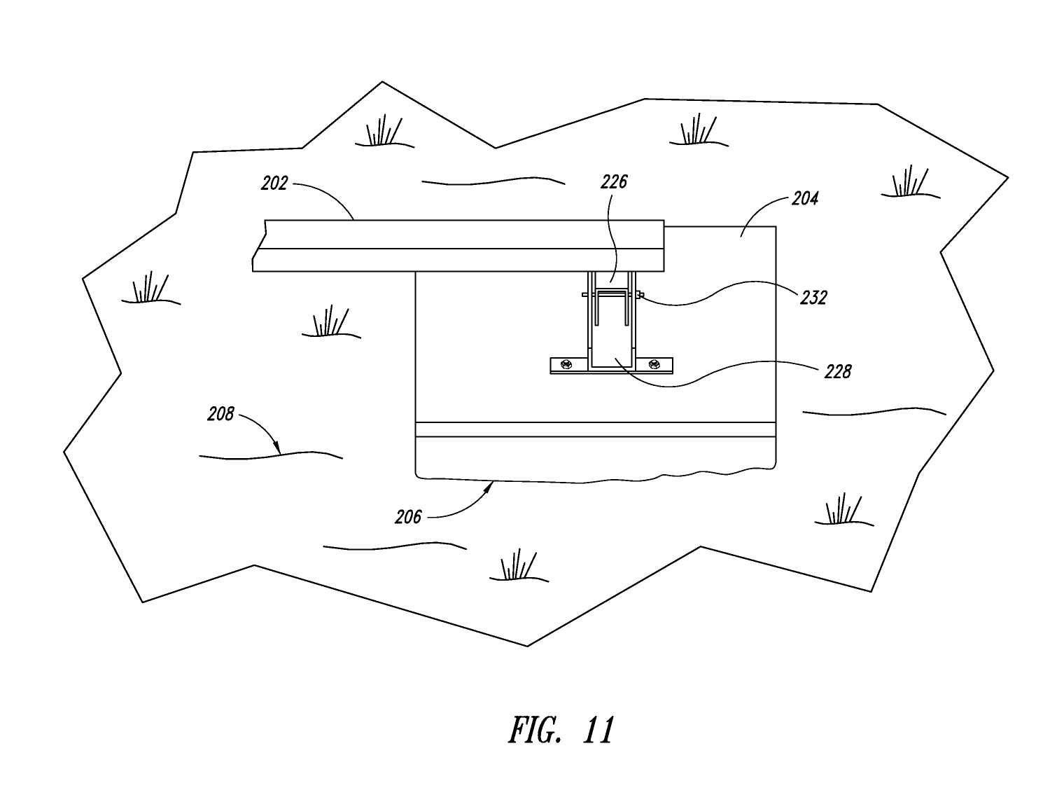

As depicted in FIG. 9, the universal platform device 200 is positioned on an inclined hill with uneven contour in different regions thereof. The general slope and contour of the primary surface 208 is different between the two respective locations where the two base members 204 are positioned. The respective base members 204 conform to the particular contour of the respective regions of the primary surface 208 on which they are positioned to stably support the support member 202. FIGS. 10 and 11 are close-up views of the two base members 204, depicting conformance of the first surface 206 of each base member 204 to different regions of the primary surface 208 having different contours. The support members 204 therefore can form a custom mating surface to conform against and grasp primary surfaces of varying contours, obviating the need to use different support devices that are each designed for a particular application.

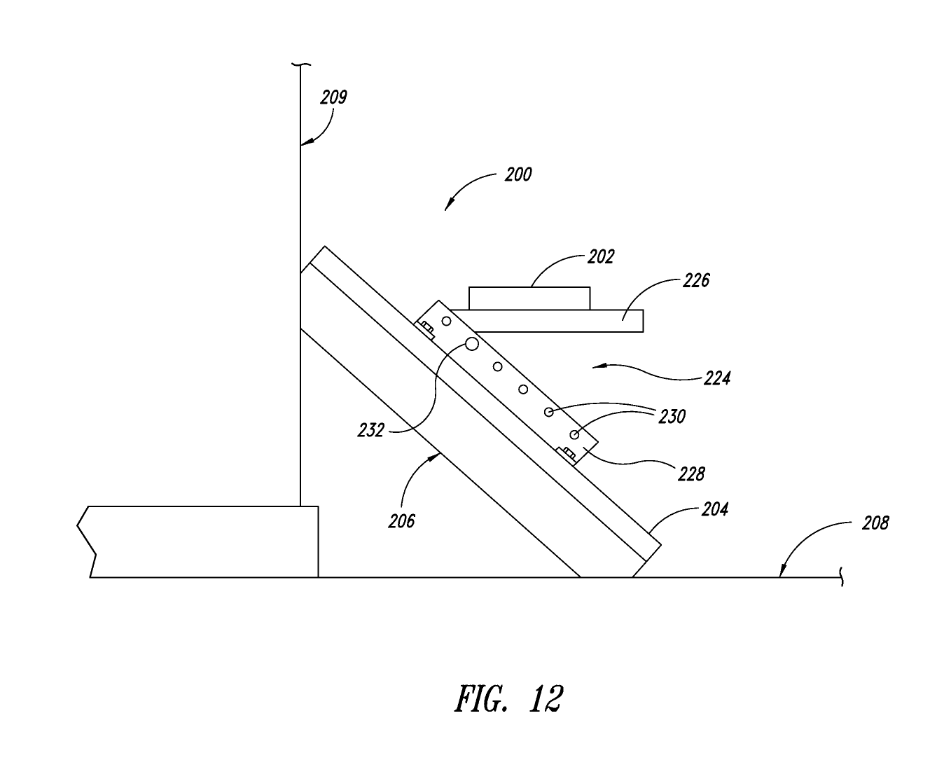

Yet another example application of the universal platform device 200 is shown in FIG. 12. As depicted in FIG. 12, the universal platform device 200 can be easily used for indoor applications, and be supported on two primary surfaces 208, 209. For example, a first portion of the base members 204 can be positioned on the ground 208 while a second portion of the base members 204 can be positioned against a wall 209, which is at an angle with respect to ground 208. The gaseous cells 210 and flexible regions 212 (FIG. 3) of the base members 204 allow the base members 204 to conform to the first and second primary surfaces 208, 209, respectively. Furthermore, the gaseous cells 210 positioned toward or at the first surface 206 of the base members 204, which are partially open toward a surrounding environment, expand upon application of pressure to grasp onto the primary surfaces 208, 209, without requiring any external fasteners, as described further above.

Conventional indoor support devices such as ladders and step stools have a wedge-shape that positions the user at a minimum distance from a location or a wall on which the user intends to work or access. Furthermore, at least in the case of ladders, portions of the ladder are typically between the user and the wall, interfering with the user comfortably accessing the area on which the user intends to work or access. In contrast to these conventional devices, the universal platform device 200 can easily provide a raised support platform without unduly spacing the user from the work area and without interfering with the user's access to the area.

The above embodiments have been described in relation to universal platform devices that have two base members 204. One of ordinary skill in the art will appreciate that a universal platform device according to another embodiment of the present disclosure can include one base member or more than two base members. Furthermore, each base member 204 can be separately and selectively pivotably coupled to the support member, allowing one base member 204 to pivot at a different angle with respect to the support member 202 than other base members 204. For example, in the indoor application depicted in FIG. 12, one of the base members 204 can be positioned flat on the ground 208 while the other base member 204 can be positioned against both the ground 208 and the wall 209.

The pivoting of the support member 202 with respect to the base members 204 can be accomplished in any manner that allows the user to adjust the positioning and orientation of the support member 202 with respect to one or more base members 204.

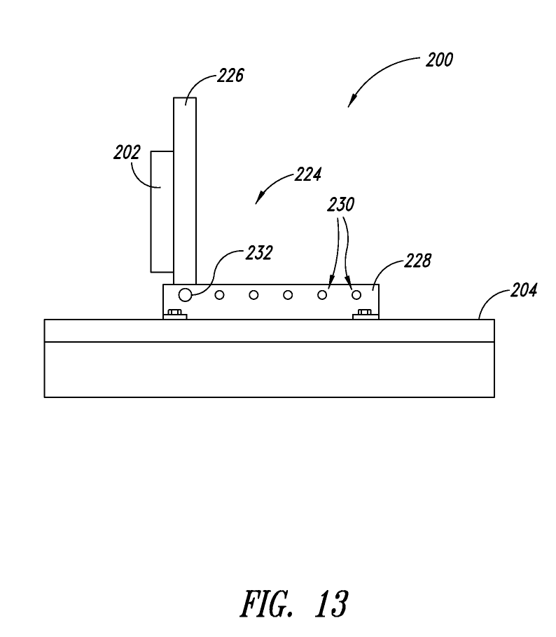

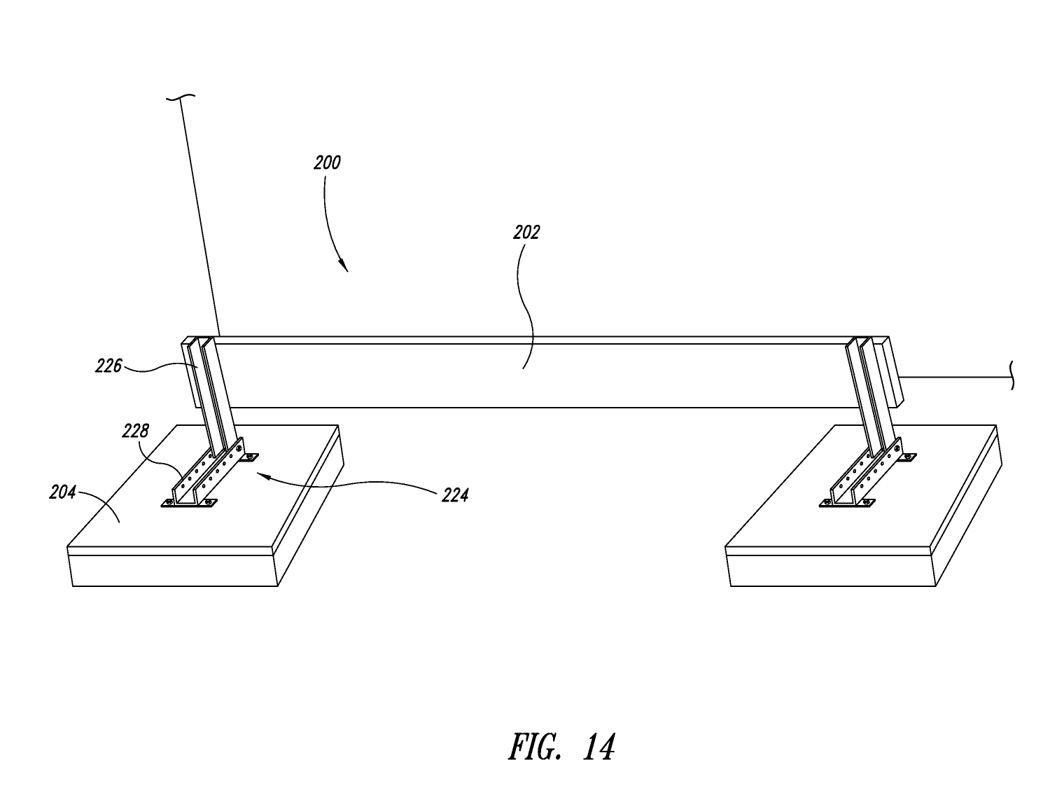

For example, as depicted in the embodiments of FIGS. 12-14, the universal platform device 200 can include an adjustment mechanism 224. Referring to FIG. 13, the adjustment mechanism 224 can include a first adjustment member 226 coupled to the support member 202 and a second adjustment member 228 coupled to the base member 204. The first adjustment member 226 is pivotably coupled to the second adjustment member 228, and at least one of the adjustment members 226, 228 includes a plurality of openings 230, which can be sequentially arranged. The adjustment mechanism 224 further includes a pin 232.

In one aspect as shown in FIGS. 12-14, the second adjustment member 228 includes a plurality of openings 230. As shown in FIG. 13, the second adjustment member 228 can be a channel with first and second legs facing each other and connected by a web extending therebetween. In this aspect, the openings 230 are formed in the first and second legs and each opening 230 in the first leg is aligned with an opening 230 in the second leg, therefore forming a plurality of pairs of openings 230 that are sequentially arranged along a length of the second adjustment member 228. The user can adjust the angle between the first and second adjustment members 226, 228, and therefore between the support member 202 and corresponding base member 204 by inserting the pin 232 through a pair of openings 230 corresponding to the desired angle.

For example, in FIG. 13, the first adjustment member 226 is shown to be at a substantially right angle with respect to the second adjustment member 228. In FIG. 12, the first adjustment member 226 is positioned at about 30 degrees with respect to the second adjustment member by inserting the pin 232 in one of the pairs of openings 230 in the second adjustment member 228, and resting the first adjustment member 226 on the pin 232. In FIG. 11, the pin 232 is inserted through a different pair of openings 230 than that shown in FIGS. 12-14, and therefore, the angle between the support member 202 and base member 204 is smaller in FIGS. 9-11, than in FIGS. 12-14.

One of ordinary skill in the art can appreciate that the adjusting mechanism 224 can incorporate openings in the first adjustment member 226 instead or as well. The plurality of openings 230 in the first adjustment member 226 can be respectively aligned with a corresponding opening or openings from the plurality of openings 230 in the second adjustment member 228 to maintain the first and second adjustment members 226, 228 at a particular angle with respect to each other. Since the adjustment members 226, 228 are coupled to the support member 202 and base member 204, respectively, maintaining the first and second adjustment members 226, 228 at an angle with respect to each other also maintains the support member 202 at substantially the same angle with respect to the base member 204. This allows a user to position the base members 204 on an inclined and/or uneven surface while maintaining the support surface of the support member 202 substantially horizontal.

Furthermore, some or all of the base members 204 can be selectively slidably coupled to the support member 202. For example, in the foregoing embodiment, the adjustment members 226, 228 can be slidably mounted to an underside of the support member 202. In one aspect, the adjustment members 226, 228 and/or the support member 202 can include at least one coupling member (not shown) that can selectively disengage the adjustment members 226, 228, respectively, from the support member 202 to allow the adjustment members 226, 228 to slide along the support member 202 to a desired position, and selectively engage the respective adjustment members 226, 228 to the support member 202 to maintain the adjustment members 226, 228 at the desired position. Such a coupling member or members can include a pin and opening combination, various detent mechanisms, or any other suitable coupling member, structure or feature.

In embodiments where an adjustment mechanism includes openings similar to those described in the preceding discussion, each of the sequentially arranged openings or pairs of openings, as the case may be, can be marked with an angle value that is achieved by inserting the pin in that opening or pair of openings. For example, the sequentially arranged openings 230 can be spaced from one another or designed so that they correspond to particular angles commonly used or associated with standard angles in certain applications, such as standard building roof angles.

In yet other embodiments, an adjustment mechanism can be designed to allow the user to position first and second adjustment members at any angle with respect to each other. For example, at least one of the first and second adjustment members can be moveable with respect to the other and be configured to engage one another, for example via complementary teeth formed on at least a portion of each member. A securing knob can be provided to allow the user to selectively move one of the first and second adjustment members toward and away from the other to engage and disengage the first and second adjustment members, to allow positioning the two members at substantially any desired angle.

In still other embodiments, the adjusting mechanism can incorporate electrical components configured to communicate with mechanical components, such as gears coupled to the adjustment members, or to support and base members, respectively, to allow automatic movement of the first and second adjustment mechanisms with respect to each other. In such embodiments, the adjustment mechanism may further include sensors electrically coupled to an interface screen and an input panel to sense and communicate the angle between the supporting member and the base members, and allow the user to use an interface to input a particular value corresponding to an angle desired to be achieved between the support member and base member.

Although the foregoing description of example embodiments generally discusses supporting individuals or objects on a support member of a universal platform device, one of ordinary skill in the art will appreciate that other embodiments can integrate an object to be supported with a universal platform device and/or configure the support member to accommodate objects therein, such as configuring the support member to include at least one receptacle and/or include shelves, or any other suitable configuration.

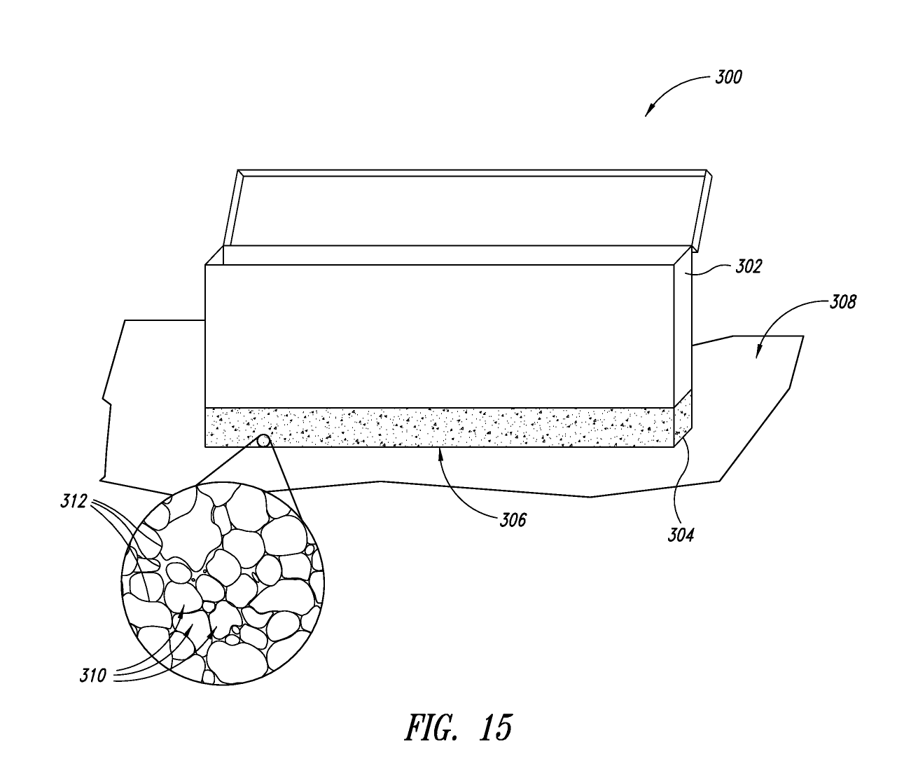

For example, FIG. 15 schematically illustrates a tool container assembly 300 according to one embodiment including a tool container 302 coupled to a base member 304 having gaseous cells 310 at least toward a region adjacent a first surface 306 thereof, and flexible regions 312 between, or surrounding, the cells 310. Similar to the previously discussed embodiments a substantial number of gaseous cells 310, internally located with respect to the first surface 306 are substantially closed cells. Furthermore, at least some of the gaseous cells 310 that are located at the first surface 306 are at least partially open toward the outside of the base member 304 to expand when placed on a primary surface 308 when subjected to a force from a weight of the tool container 302 and/or its contents. When the weight is applied to the base member 304, the base member 304 deforms, expanding the gaseous cells 310 at the first surface 306 and creating suction between these cells and a primary surface 308 to grasp onto the primary surface 308.

The base member 304 can be fixedly coupled to the tool container 302 by any suitable method, such as adhesively, using fasteners, including mechanical fasteners, or via an intermediate mounting member to which the base member 304 is preassembled, or any other suitable method. Such a tool container is not limited in application and presents immense advantages in numerous fields of use.

For example, for roofing applications, the tool container assembly 300 can be easily placed proximate the user in any weather, the first surface 306 substantially conforming to the roof to support the tool container 302 on the roof via the plurality of gaseous cells 310 and flexible regions 312. When the user moves to a different location on the roof, the tool container assembly 300 can be easily moved by lifting and relocating the tool container assembly 300.

Similarly fire fighting personnel can use the tool container assembly 300 to reduce the risk of injury when fighting fires from a surface that is over a fire. For example, a common fire fighting technique with respect to buildings or houses is to position fire fighting personnel on the roof of the building where the roof is either already compromised or is deliberately broken down by fire fighters to spray the fire with water or other fire extinguishing spray from above. Typically, fire fighters carry their equipment on them, either in heavy back packs or on their articles of clothing. One reason for carrying these tools on them is the risk of losing them for example by the back pack falling from the roof or slipping under wet conditions that the roof is exposed to at time of fighting the fire. Since the aggregate of these tools is heavy and adds to the weight of the fire fighters, often fire fighters are injured by the roof collapsing at locations where they are positioned due to a heavy weight being concentrated on a small area, for example under their feet, or between their knees and their feet when they are kneeling to fight a fire below.

In contrast, the tool container assembly 300 substantially alleviates concerns about slippage on the roof and fire fighters can carry the tool container assembly 300 until they reach the roof and then place it on the roof, knowing that the base member 304 will substantially prevent slippage on any surface. Therefore, the weight of the tool container assembly 300 is not added to the weight of the fire fighter, and the total weight is thus not concentrated on an area defined by a portion of the fire fighter's anatomy that supports the fire fighter on the roof. Instead, the weight of the tool container assembly 300 is distributed along an area defined by the first surface 306 of the base member 304, or a portion thereof, which is supported by a primary surface 308 such as a portion of the roof.

Other applications for effectively and efficiently using the tool container assembly 300 include landscaping applications on any terrain, including uneven and inclined terrains, or even slippery terrains. A landscaper can have easy access to his or her tools and easily transport the tools as the landscaper moves about to conduct his or her work. Yet other applications include cleaning glass at high heights, such as sky lights that are on inclined roof surfaces.

These applications are provided as examples of applications for which the tool container assembly 300 can be used to provide a thorough understanding of this embodiment. One of ordinary skill in the art will appreciate other suitable applications and that modifications can be made to the tool container assembly described above to make it suitable for other applications without deviating from the scope of the present disclosure and the claims that follow.

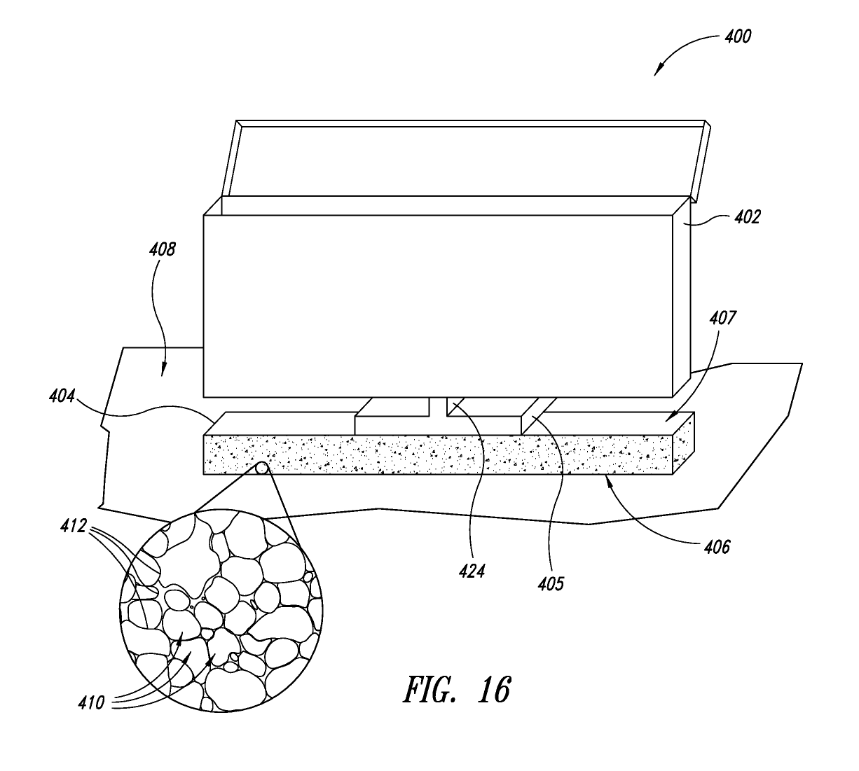

For example, FIG. 16 schematically illustrates yet another embodiment of a tool container assembly 400 including a tool container 402 pivotably coupled to a base member 404. Similar to the previous embodiment, the base member 404 has gaseous cells 410 at least toward a region adjacent a first surface 406 thereof, and flexible regions 412 between, or surrounding, the gaseous cells 410. The tool container assembly 400 can include a mounting member 405 that is fixedly coupled toward a second surface 407 of the base member 402, opposing the first surface 406 thereof, the mounting member 405 being pivotably coupled to the tool container 402. The mounting member 405 can be pivotably coupled to the tool container 402 either directly or indirectly. For example, the mounting member 405 and tool container 402 can be coupled to an adjusting mechanism 424 that enables selective control over positioning and orientation of the tool container 402 with respect to the mounting member 405, and therefore, with respect to the base member 404. The adjusting mechanism 424 can be any suitable adjusting mechanism, including those described herein with respect to other embodiments. In some applications a wedge can be used instead.

The tool container assembly 400 pivotably coupled to the base member 404 can be used in any of the above-described applications, and the tool container 402 can be pivoted with respect to the base member 404 to more conveniently access contents of the tool container 402 and more effectively prevent tools from inadvertently falling out from an interior of the tool container 402 on an inclined primary surface 408, such as roofs, hillsides, or any other surface.

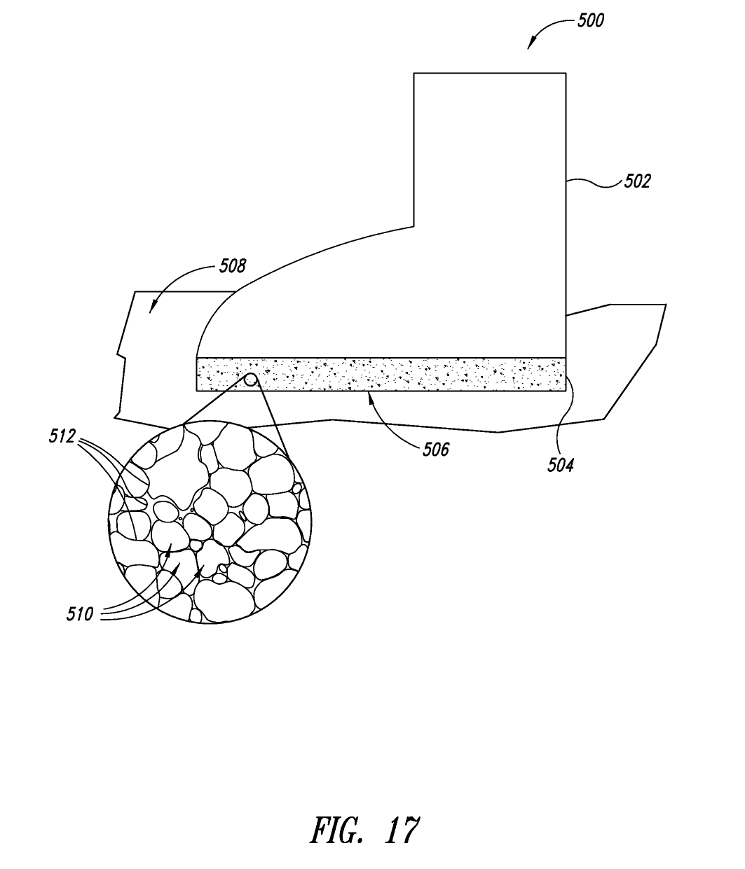

FIG. 17 schematically illustrates yet another embodiment, in which a support footwear 500 includes a footwear 502 coupled to a base member 504 having gaseous cells 510 at least toward a region thereof adjacent a first surface 506 thereof, and flexible regions 512 between, or surrounding, the gaseous cells 510. The base member 504 can serve as the sole of the footwear 502 or be coupled to a separate sole, for example to a rubber or other sole. The support footwear 500 can be used in any of the applications discussed above for added support on inclined or oddly contoured primary surfaces 508, or it can be used for hiking such surfaces, even in snow or ice where the surfaces are slippery. Such footwear can be used for sports activities on slippery, contoured and/or inclined surfaces, including hiking, climbing and sports for which snow shoes are currently used, to prevent slipping.

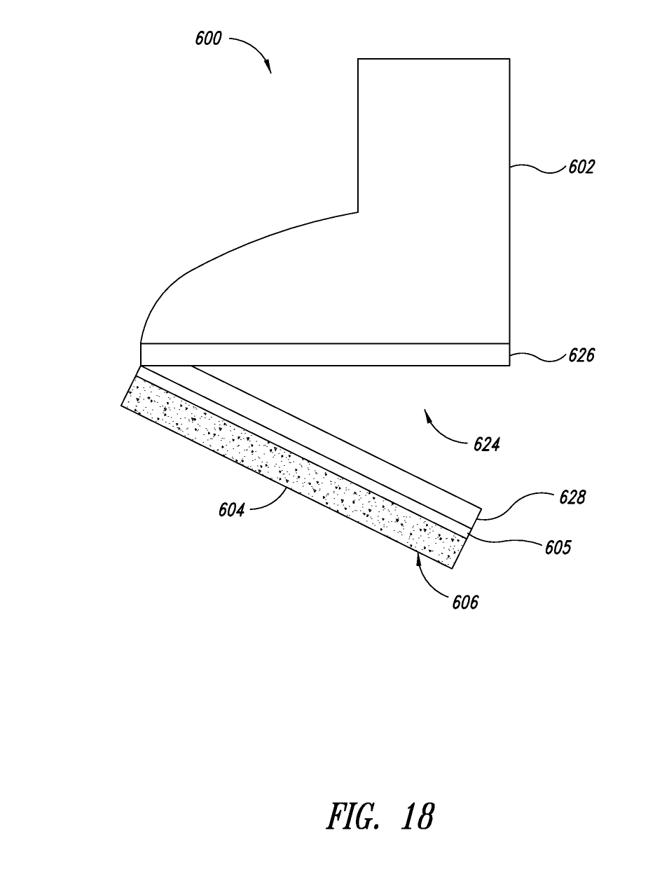

FIG. 18 schematically illustrates a support footwear 600 according to yet another embodiment, in which the footwear 602 is selectively pivotably coupled to the base member 604. For example, the support footwear 600 can include a wedge or an adjustment mechanism 624 operable to allow the support footwear 602 angled with respect to the base member 604. In one aspect, the adjusting mechanism 624 can include first and second adjustment members 626, 628, which can be similar to adjustment members discussed herein with respect to other embodiments, scaled down to a smaller to size to better suit a footwear embodiment, such as that illustrated in FIG. 18.

The first adjustment member 626 is coupled to the footwear 602 and the second adjustment member 628 is coupled to the base member 604, either directly or indirectly, for example via a mounting member 605, which in turn is fixedly coupled to the base member 604. The user can therefore wear the support footwear 600 and stand on an inclined surface while being able to adjust the angle of the user's foot with respect to the inclined surface. Furthermore, since the base member 604 substantially conforms at the first surface 606 thereof to a primary surface, the gaseous cells at the first surface 606 respectively expand and create suction against the primary surface across substantially the entire first surface 606 to securely support the user.

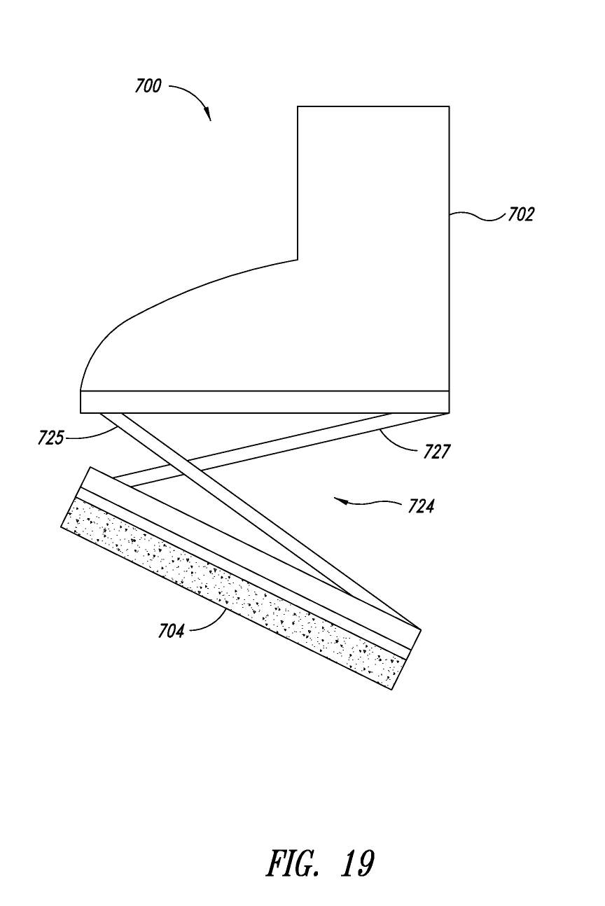

FIG. 19 illustrates still another embodiment of a support footwear 700 including a support mechanism 724, which includes third and fourth adjustment members 725, 727 pivotably coupled to the footwear 702 and the base member 704. The adjustment members 725, 727 are configured to engage one another at a location that is between opposing ends of the first and second adjustment members 725, 727, for transferring the user's weight to the base member 704 at a more intermediate location with respect to the user's feet and provide a more stable and comfortable support on inclined surfaces.

One of ordinary skill in the art will appreciate that some embodiments can incorporate other devices, structures, features or mechanisms that provide additional operability of the platform device, which may be useful for supporting or manipulating a weight on substantially all types of surfaces.

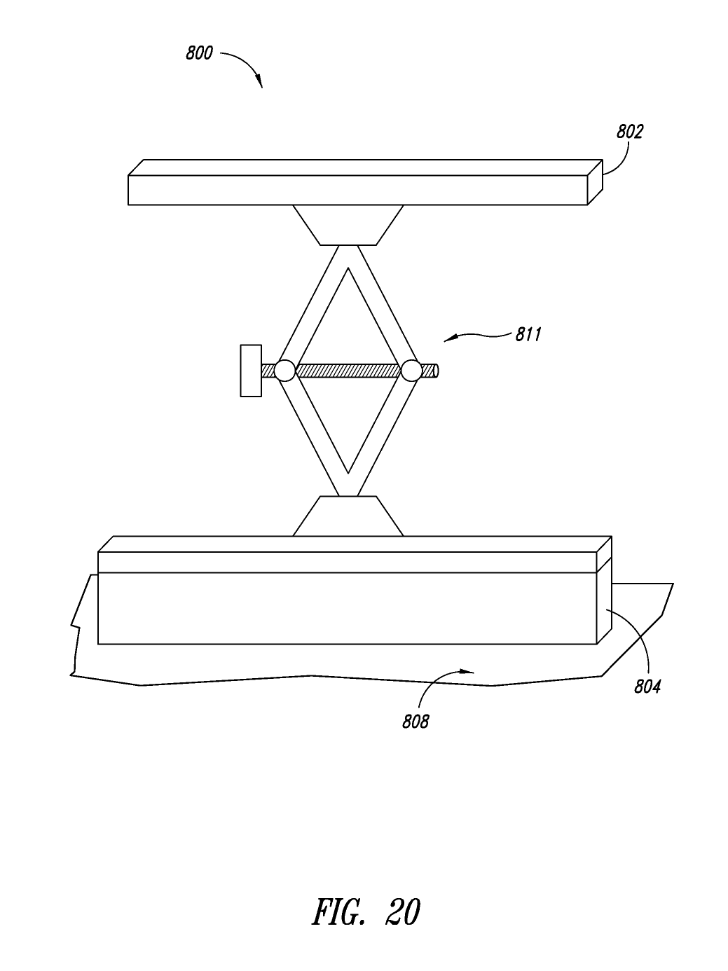

For example, FIG. 20 schematically illustrates a universal platform device 800 according to another embodiment, including a support member 802, a base member 804 having cells separated by flexible regions or membranes similar to those described with respect to other embodiments, and a lift mechanism 811 positioned between the support member 802 and base member 804. The lift mechanism 811 can be selectively operable to lift the support member 802 and an individual or an object thereon, while the base member 804 supports the universal platform device 800 and the weight supported thereby on a primary surface 808, such as an inclined surface. Similar to other embodiments, the aforementioned components can be pivotably coupled to allow orienting the support member 802 with respect to the base member 804.

In the illustrated embodiment of FIG. 20, a jackscrew is illustrated as an example of the lift mechanism 808; however, any suitable lift mechanism can be incorporated, including hydraulic or pneumatic lift mechanisms.

All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A universal platform device configured to support a weight of an object or person on at least one primary surface, the universal platform device comprising:
at least one support member configured to support the weight; and
at least one base member having a first surface configured to be positioned on the primary surface along at least a mating portion of the first surface, the base member being coupled to the support member and including a plurality of gaseous cells at least toward the first surface, and a flexible material at least between the respective gaseous cells, the flexible material and the gaseous cells being deformable and the shape of the mating portion being substantially conformable to a shape of the primary surface in response to the universal platform device being subjected to the weight, the base member clasping to the primary surface in response to deformation of the flexible material and the gaseous cells.

2. The universal platform device of claim 1 wherein the support member is pivotably coupled with respect to the at least one base member.

3. The universal platform device of claim 1, further comprising:
an adjustment mechanism positioned between the support member and the at least one base member, the adjustment mechanism being selectively operable to adjust a positioning or orientation of the support member with respect to each base member.

4. The universal platform device of claim 3 wherein the adjustment mechanism includes a pin member, a first adjustment member coupled to the support member and a second adjustment member coupled to the base member, the first adjustment member being pivotably mounted with respect to the second adjustment member, at least one of the first and second adjustment members having a plurality of openings sequentially arranged, the pin being insertable in the openings to maintain a desired angle between the first and second adjustment members.

5. The universal platform device of claim 3 wherein the adjustment mechanism includes a first adjustment member coupled to the support member, a second adjustment member coupled to the base member, and a fastening mechanism, the first adjustment member being pivotably mounted with respect to the second adjustment member, the fastening mechanism configured to be selectively fastened to maintain a desired angle between the first and second adjustment members, and to be selectively unfastened to allow selective pivoting of the first adjustment member with respect to the second adjustment member.

6. The universal platform device of claim 3, further comprising:
a lifting mechanism positioned between the support member and the base member, the lifting mechanism being selectively operable to vary a distance between the support and base members.

7. The universal platform device of claim 1 wherein the base member includes a foam material.

8. The universal platform device of claim 6 wherein the foam material includes at least one of dense foam, memory foam, latex foam, plastic foam, and high specification foam.

9. The universal platform device of claim 1 wherein substantially all of the gaseous cells internally positioned with respect to the first surface of the base member are closed cells, and at least some of the gaseous cells positioned at the first surface are open cells.

10. The universal platform device of claim 1 wherein the base member includes at least one viscoelastic material.

11. A base for a platform supporting a weight of an object or person on an inclined surface, the base comprising:
at least one support member configured to support the weight; and
at least one base member having a first surface configured to be positioned on the primary surface along at least a mating portion of the first surface, the base member being coupled to the support member and including a plurality of gaseous cells at least toward the first surface, and a flexible material at least between the respective gaseous cells, the flexible material and the gaseous cells being deformable and the shape of the mating portion being substantially conformable to a shape of the primary surface in response to the universal platform device being subjected to the weight, the base member clasping to the primary surface in response to deformation of the flexible material and the gaseous cells.
